(19) United States
(12) Patent Application Publication
(10) Pub. No.: US 2010/0306940 A1
(43) Pub. Date: Dec. 9, 2010

(54) RECEIVE STRUCTURE OR PORTABLE TOOTHPASTE

(76) Inventor: Young-Sun Park, Jeollabuk-do (KR)

Correspondence Address: Hershkovitz & Associates, LLC, 2845 Duke Street, Alexandria, VA, 22314, US

(21) Appl. No.: 12/810,299

(22) PCT Filed: Dec. 22, 2008
(86) PCT No.: PCT/KR08/07570

§ 371 Date: Aug. 7, 2010

(30) Foreign Application Priority Data
Dec. 24, 2007 (KR) 20-2007-0020628

(51) Int. Cl. A46B 9/04; B25G 1/00

(52) U.S. Cl. 15/143.1

(57) ABSTRACT

This present idea improves the organization, convenience, and sanitary conditions of conventional portable tooth brushes by equipping it with an additional storage room for toothpaste, dental floss, and proxabrush, which is partitioned by separate walls for each appliance with a one-touch lid for an easier access. Additionally, the construction of the lid allows the dental appliances to naturally dry off while stored.

### TECHNICAL FIELD

The present idea is about the construction of a storage-equipped portable toothbrush, especially improving the organization, convenience, and sanitary condition of portable toothbrushes to be used outdoor and while traveling with a built-in space to hold additional dental appliances such as toothpaste, dental floss, and proxabrush.

### BACKGROUND ART

Generally, toothbrushes are used to brush teeth, meaning applying toothpaste to a toothbrush to remove food residues between the teeth and the gum, in order to eliminate plaque or other harmful bacteria.

Thus, a toothbrush must be stored with toothpaste at all times. At home or at office, it is of no inconvenience but on outdoor setting or while traveling, it is risky and difficult to carry both a toothbrush and toothpaste separately. The convenience of a portable toothbrush solves this problem and therefore it is widely used outdoor or while traveling.

As shown in FIG. 1, this type of portable toothbrush is constituted of a brush (1), a handle (2), and a bar (3) that interconnects them and a brush (1) is protected through a cap (4).

Inside a handle (2), there is a storage room (5) to store additional dental appliances such as toothpaste, dental floss, and proxabrush, and this storage room (5) is protected by a lid (6).

Therefore, the current circumstance only allows a lid (6) open the storage space where additional dental appliances are kept when necessary and shut it tight when not in use.

### DISCLOSURE OF INVENTION

### Technical Problem

However, the conventional design of completely closing in or removing the cap in order to use additional dental appliances creates unnecessary inconvenience.

Also, all dental appliances are stored together without any methods of partition, which not only is inconvenient but also creates the possibility of different appliances for example, dental floss with toothpaste or proxabrush to become entangled.

Thus, this design strives to solve facilitating usage and partitioning various dental appliances in order to solve the traditional problem and increasing sanitation.

This design's purpose is to enhance convenient access to additional dental appliances by attaching a cap capable of one-touch opening and closing.

This design's other purpose is to provide a reformed storage space in a portable toothbrush by partitioning the storage space to separate dental appliances.

This design's another purpose is to provide a storage space in a portable toothbrush capable of natural ventilation, which prevents loss of hygiene.

### Technical Solution

The primary purpose of the design is composed of a brush, which is connected by a bar to a handle with a built-in storage space that can be opened or closed by a cap and it is achieved through constructing a cap with a stationary opening to expose storage space partitioned by a wall and a hinged top lid that can be opened or shut with one touch.

### Advantageous Effects

The above design can enlarge the convenience of accessing additional dental appliances through attaching a cap with a stationary opening, which is hinged to a top lid capable of one-touch opening or closing.

Also, the partitioned storage space allows various appliances, such as toothpaste, dental floss, and proxabrush to easily be carried together and it also facilitates an access to only the needed appliances.

Furthermore, it would be a practical design that maintains sanitation of the additional dental appliances by separating them and allowing maximum natural ventilation while in storage through its ventilation opening on the cap.

### BRIEF DESCRIPTION OF DRAWINGS

FIG. 1 is the sketch of conventional portable toothbrush.

FIG. 2 is the magnified view of the designed portable toothbrush.

FIG. 3 is the disassembled sketch of the designed portable toothbrush.

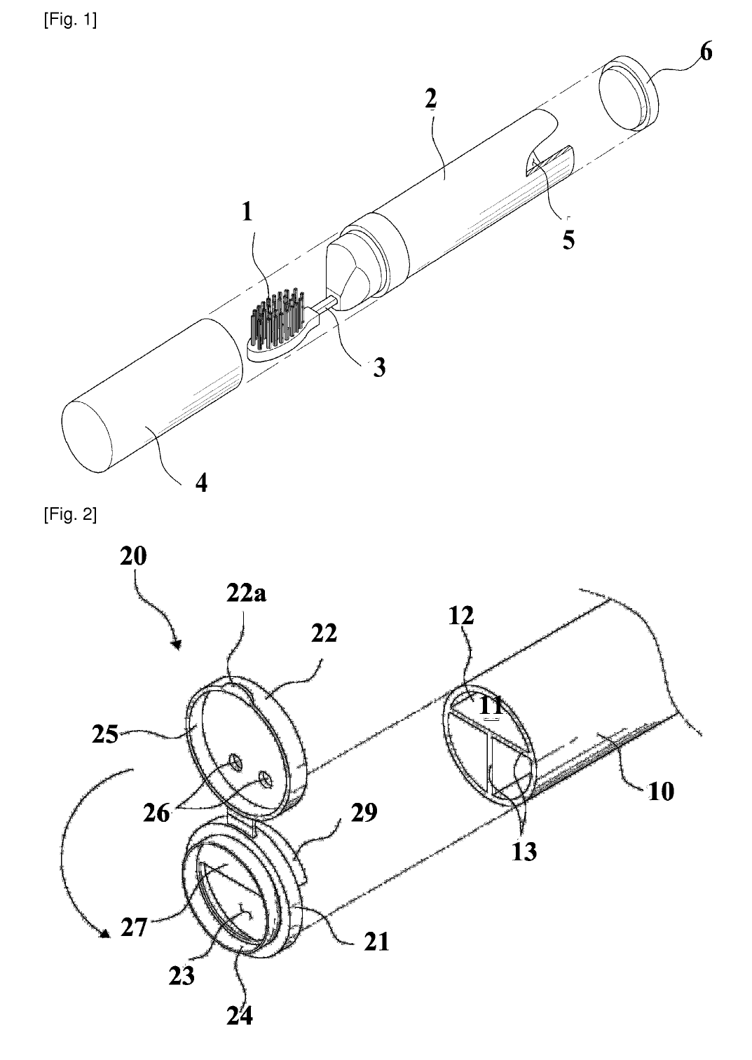

### BEST MODE FOR CARRYING OUT THE INVENTION

Following is the most desirable mean of achieving the presented design according to the drawings.

FIG. 2 is the cast view of a portable toothbrush according to suggested design. It contains a built-in storage space divided by a partition and a stationary opening and a top cap can be viewed at the opening of the storage place.

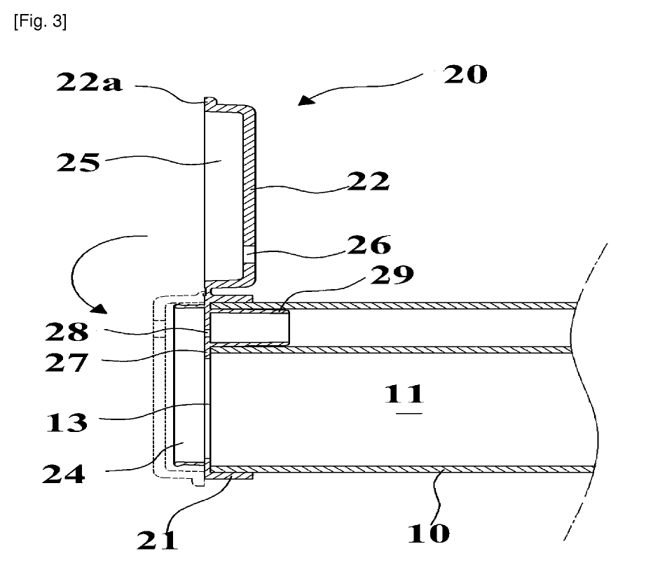

FIG. 3 shows the part of the storage space according to the suggested design of a portable toothbrush and the inner construction and a movement to open or close the storage space can be viewed as well.

Therefore, as shown in FIG. 2 or FIG. 3, the storage space of a portable toothbrush is composed of a storage space for additional dental appliances (11) in a handle (10) and the opening of the storage (11) can be opened or closed by a cap (20).

Here, the additional dental appliances stored in a storage space (11) comprise of a dental floss to remove residues between teeth and gums, proxabrush to remove residues between teeth and other necessary appliances in brushing teeth.

The cap (20) suggested in this design includes one-touch top (22) that is attached to a stationary opening (21) and the opening (12) of the storage space (11) that stores additional dental appliances and it is hinged to a stationary top (21).

Thus, the stationary opening (21) creates a entrance (23) to access additional dental appliances stored in a storage space (11) and it is to be attached or inserted to an opening (21) of a storage space (11). The suggested design shows it inserted.

The top (22) that is hinged to a stationary opening (21) is closed when not in use. When in use, the top (22) is to be opened with one touch from the stationary top (21) to either store or withdraw additional dental appliances stored in a storage room (11).

In order for a top (22) to be operated on one touch, there is a projected wall inside the stationary top (21) the opposite end of the adjoining section (12), and the inside of a top (22) shows an accommodating section (25) in order to lodge the inner rim (24).

Therefore, a cap (20) that includes a stationary part (21) and a top (22) is inserted into an opening (12) to store additional appliances at a storage space (11) when not in use and to easily pop out the top (22) by one-touch when needed.

The storage space (11) according to the design is provided with a partition (13) to separately store additional appliances, which prevents these appliances from entangling.

The drawing suggests a T-shaped partition (13) in storage (11) but this is only an example and the shape of a partition (13) in storage (11) is up to the request of a customer.

Thus, additional dental appliances are stored separately at storage (11) by the partition (13) created in the storage space (11) and the access is greatly facilitated especially in the case of a dental floss.

On the other hand, there are main ventilating openings (26) on the top (22) to naturally ventilate the storage space (11).

The design allows a natural ventilation through the top (22) to completely dry off those additional dental appliances that have been stored at a storage space (11) without having been completely dried. The most desirable design would shape the main ventilating openings (26) in a pair in order to aid undisturbed air ventilation.

In addition, the stationary top (21) in this design closes off part of the entrance (23) of the storage space (11) by a partition (28) for those customers who do not wish to disclose their usage of additional dental appliances.

As a result, those customers who do not wish other to see additional dental appliances in a storage space (11) can carry this toothbrush without a worry because the screen (27) that closes off part of an entrance (23) to a storage space (11) prevents exposure.

It is also desirable the screen (27) is also formed with assistant ventilating openings (28) in addition to the main ventilating openings (26) to prevent sanitary problems of additional dental appliances.

Moreover, there is a projected product keeper (29) on the entrance (12) or the back of the screen (27) and this prevents the cap (20) from break away from the handle (10).

Therefore, a portable toothbrush according to design allows easy access to needed dental appliances through a one-touch top (22) and adds convenience by organizing the storage space (11) for customers needs.

On the other hand, the edge of the top (22) is designed projecting externally for an easier opening of the top (22). Thus the drawing shows the projection (22a) on the edge of the top (22).

1. A structure comprising a brush that is fixed to a handle with a built-in storage room for additional dental appliances with an end lid for opening and closing of the storage space, wherein the entire lid is comprised of a stationary opening to expose dental appliances and a hinged top lid that can be opened or shut with one touch, and the internal storage room being especially designed to separate each dental appliance.

2. The structure according to claim 1, wherein the top lid of a portable tooth brush is specially designed with ventilating opening to allow natural air to dry off the storage space

3. The structure according to claim 1, wherein the top lid of a portable toothbrush specially partitions to close off a part of the stationary opening while the partition has the assistant ventilating opening in addition to the main ventilating opening to allow the closed-off storage space to naturally dry off.

4. The structure according to claim 3, wherein the top partition of a portable toothbrush is specially constituted of a projected product keeper.

5. The structure according to claim 1, wherein the edge of top lid of a portable toothbrush is specially formed with some projected sections.

6. The structure according to claim 2, wherein the top lid of a portable toothbrush specially partitions to close off a part of the stationary opening while the partition has the assistant ventilating opening in addition to the main ventilating opening to allow the closed-off storage space to naturally dry off.

7. The structure according to claim 2, wherein the edge of top lid of a portable toothbrush is specially formed with some projected sections.

8. The structure according to claim 4, wherein the top lid of a portable toothbrush specially partitions to close off a part of the stationary opening while the partition has the assistant ventilating opening in addition to the main ventilating opening to allow the closed-off storage space to naturally dry off.
